(19) United States
(12) Patent Application Publication
(10) Pub. No.: US 2005/0070165 A1
(43) Pub. Date: Mar. 31, 2005

(54) Card adapter including metallic cover member connected to ground

(75) Inventor: Yuichiro Ikeda, Miyagi-ken (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 10/930,519

(22) Filed: Aug. 30, 2004

(30) Foreign Application Priority Data
Sep. 29, 2003 (JP) 2003-337908

(51) Int. Cl. H01R 24/00

(52) U.S. Cl. 439/630

(57) ABSTRACT

According to the present invention, there is provided a card adapter which is capable of preventing contact failure between a cover member and a ground terminal caused by the floating of the cover member when a card is inserted into a card inserting portion. A contacting surface 40 facing a back-end surface 1b of the card inserting portion 1a is provided on the ground terminal 12. A ground contacting portion 41 comprising a contacting portion 41a brought into contact with the contacting surface 40, a plate spring portion 41b extending in a widthwise direction of the card inserting portion 1a and bent in a lengthwise direction of the card inserting portion 1a, and a cantilever supporting portion 41c for supporting the plate spring portion 41b in a cantilever manner is formed in a bent portion 4a provided in a front-end portion of the cover member 4. In addition, in a lengthwise direction of the card inserting portion 1a, the contacting portion 41a of the ground contacting portion 41 is pressed against the contacting surface 40 of the ground terminal 12 to be brought into contact with each other through the elastic force of the plate spring portion 41b.

### BACKGROUND OF THE INVENTION

1. Field of the Invention

The present invention relates to a card adapter, connected to a ground, having a metallic cover member that covers a card inserting portion into which a card is inserted.

2. Description of the Related Art

Generally, each of card adapters typically comprise a card inserting portion, into which a card having an external terminal group exposed in a surface thereof is inserted, an adapter terminal group that is exposed in the interior and exterior of the card inserting portion and is brought into contact with the external terminal group of the card inserted into the card inserting portion, and a metallic cover member covering the card inserting portion and having a ground contacting portion which is brought into contact with a ground terminal of the adapter terminal group (for example, refer to Japanese Unexamined Patent Application Publication No. 2000-40131).

In such conventional card adapters, the cover member is arranged so as to be opposite to a bottom plate of the card inserting portion and the ground contacting portion of the cover member is brought into contact with the ground terminal in the thickness direction of the card inserting portion, to connect the cover member to the ground.

However, in the above-mentioned conventional card adapters, because the ground contacting portion of the cover member is brought into contact with the ground terminal in the thickness direction of the card inserting portion, when a card is inserted into the card inserting portion, the cover member often floats to cause contact failure between the ground contacting portion and the ground terminal. Further, as a result of having contact failure between the cover member and the ground terminal, the cover member cannot be connected to the ground. Thus, it is difficult to protect the card and the card adapter from static electricity or the like.

Accordingly, the present invention is designed to solve the above-mentioned problems, and it is an object of the present invention to provide a card adapter which is capable of preventing contact failure between a cover member and a ground terminal caused by the floating of the cover member when a card is inserted into a card inserting portion.

In order to achieve the above-mentioned object, the present invention provides a card adapter which comprises a card inserting portion into which a card having an external terminal group exposed in a surface thereof is inserted, an adapter terminal group that is exposed in the interior and exterior of the card inserting portion and is brought into contact with the external terminal group of the card inserted into the card inserting portion, and a metallic cover member covering the card inserting portion and having a ground contacting portion which is brought into contact with a ground terminal of the adapter terminal group. In addition, the ground contacting portion is brought into contact with the ground terminal in a lengthwise direction of the card inserting portion.

According to the present invention having the above-mentioned configuration, the ground contacting portion is brought into contact with the ground terminal in a lengthwise direction of the card inserting portion. For this reason, even when the cover member floats, the ground contacting portion is not separated from the ground terminal. Therefore, it is possible to prevent the contact failure between the cover member and the ground terminal caused by the floating of the cover member when the card is inserted into the card inserting portion.

In addition, according to the present invention, the ground terminal has a contacting surface facing a back-end surface of the card inserting portion, and the ground contacting portion is formed in a bent portion obtained by bending a front-end portion of the cover member. The ground contacting portion comprises a plate spring portion extending in a widthwise direction of the card inserting portion and bent in a lengthwise direction of the card inserting portion and a cantilever supporting portion for supporting the plate spring portion in a cantilever manner.

According to the present invention having the above-mentioned configuration, it is possible to press the ground contacting portion against the contacting surface of the ground terminal to be brought into contact with each other through elastic force of the plate spring portion. As a result, it is possible to stabilize the contact of the ground contacting portion to the ground terminal. In addition, since the plate spring portion of the ground contacting portion is formed so as to extend in the widthwise direction of the card inserting portion, it is possible to provide elasticity to the ground contacting portion without enlarging the size of the ground contacting portion in the thickness direction of the card inserting portion.

In addition, according to the present invention, the card adapter further comprises locking means for locking the cover member in a frame portion by sliding the cover member in a lengthwise direction of the card inserting portion in a state where the cover member is arranged at a predetermined position of the frame portion which forms sidewalls of the card inserting portion.

According to the present invention having the above-mentioned configuration, it is possible to easily assemble the cover member by the locking means.

In addition, according to the present invention, locating portions for locating the cover member in a thickness direction of the card inserting portion are formed in the cover member.

According to the present invention having the above-mentioned configuration, the cover member can be accurately arranged at a predetermined position in a thickness direction of the card inserting portion by the locating portions. As a result, the ground contacting portion can be accurately arranged toward the ground terminal.

As described above, according to the present invention, even when the cover member floats, the ground contacting portion is not separated from the ground terminal. As a result, when a card is inserted into the card inserting portion, it is possible to prevent contact failure between the cover member and the ground terminal from occurring. Therefore, it is possible to protect the card and the card adapter from static electricity or the like.

### BRIEF DESCRIPTION OF THE DRAWINGS

FIG. 1 is an enlarged plan view of a card adapter according to a first embodiment of the present invention;

FIG. 2 is a back surface view of the embodiment shown in FIG. 1;

FIG. 3 is a plan view illustrating a state where an upper case is removed from the embodiment shown in FIG. 1;

FIG. 4 is a sectional view taken along the line IV-IV of FIG. 3;

FIG. 5 is a view illustrating a case where a cover member shown in FIG. 3 is viewed from a direction V;

FIG. 6 is a view illustrating a case where the cover member shown in FIG. 3 is viewed from a direction VI;

FIG. 7 is a plan view illustrating a state before the cover member is locked into a frame portion where the cover member is arranged on the frame portion of a lower case; and

FIG. 8 is a plan view illustrating a state where the cover member is locked into the frame portion.

### DESCRIPTION OF THE PREFERRED EMBODIMENTS

An embodiment of a card adapter of the present invention will now be described with reference to the accompanying drawings.

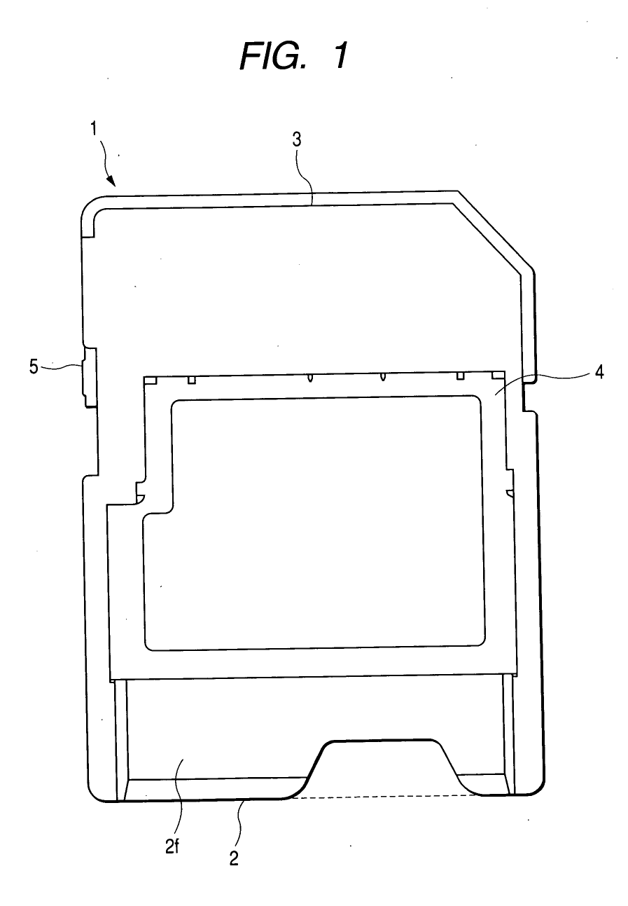

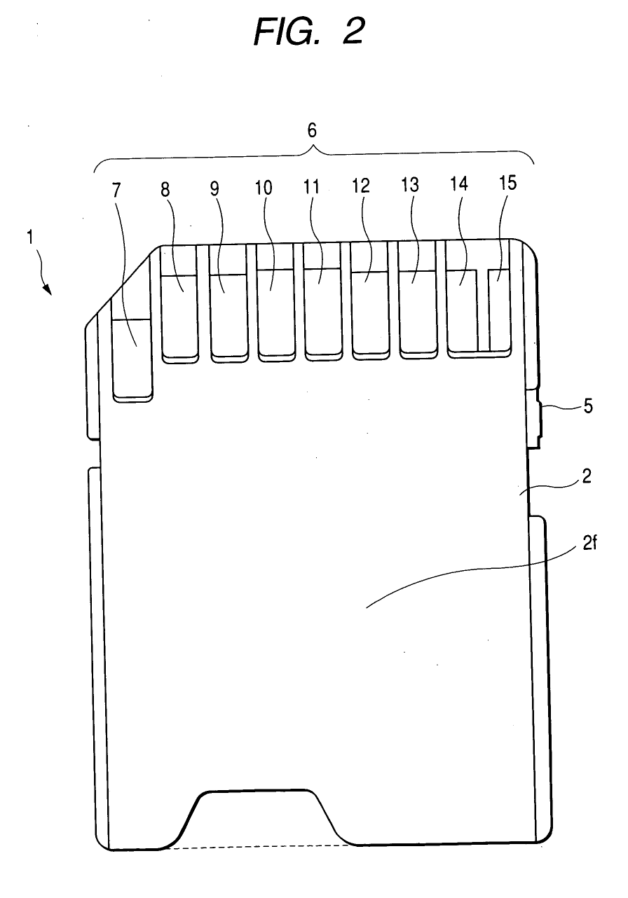

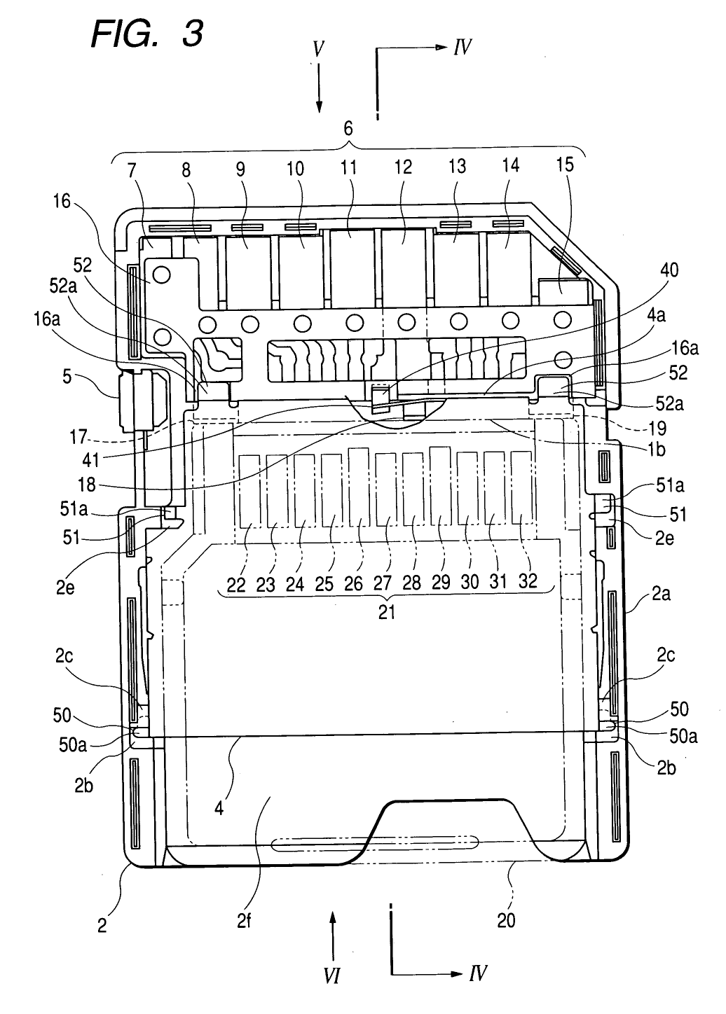

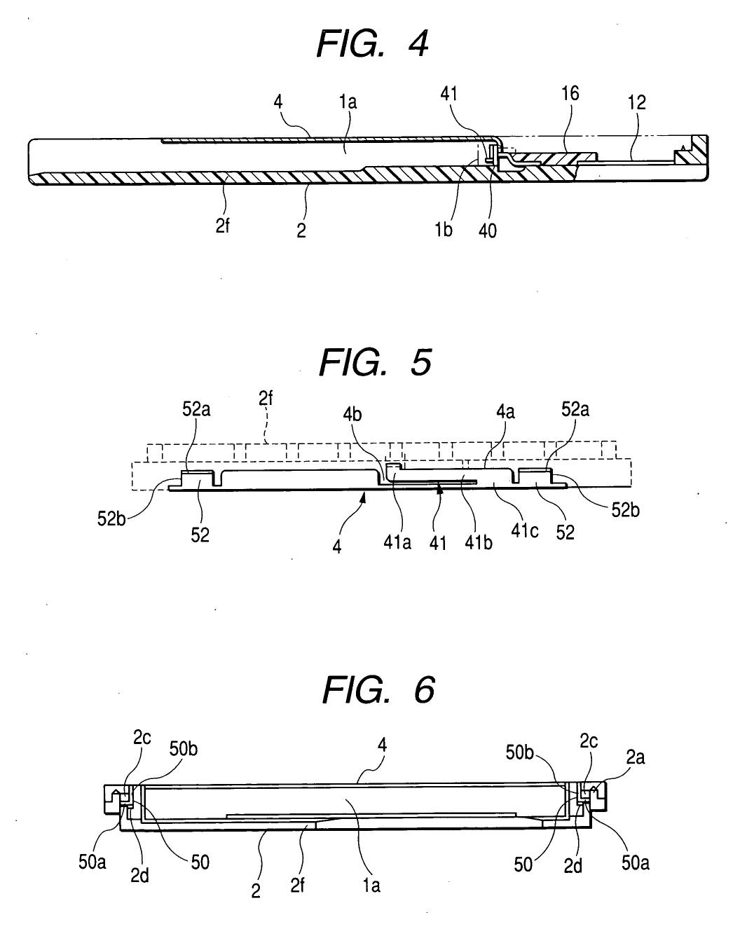

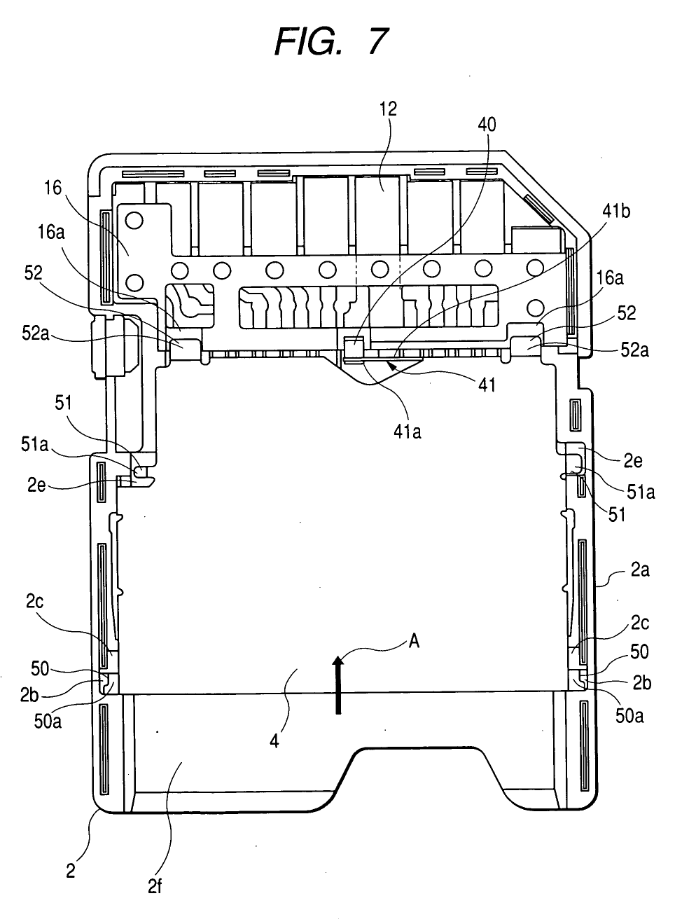

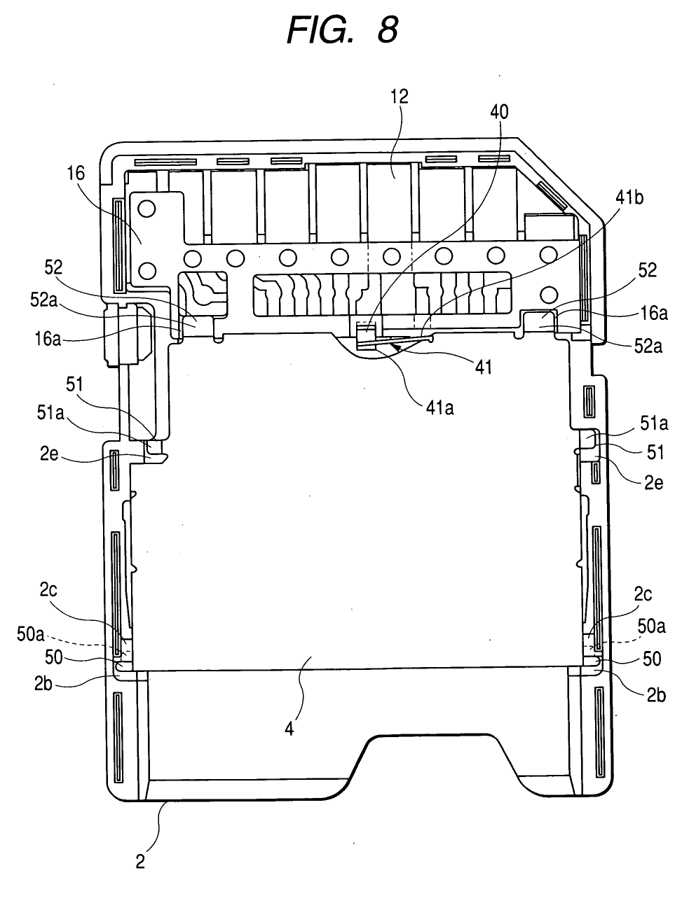

FIG. 1 is a plan view of a card adapter according to a first embodiment of the present invention; FIG. 2 is a back surface view of the embodiment shown in FIG. 1; FIG. 3 is a plan view illustrating a state where an upper case is removed from the embodiment shown in FIG. 1; FIG. 4 is a sectional view taken along the line IV-IV of FIG. 3; FIG. 5 is a view illustrating a case where the cover member shown in FIG. 3 is viewed from a direction V; FIG. 6 is a view illustrating a case where the cover member shown in FIG. 3 is viewed from a direction VI; FIG. 7 is a plan view illustrating a state before the cover member is locked into a frame portion where the cover member is arranged on the frame portion of a lower case; and FIG. 8 is a plan view illustrating a state where the cover member is locked into the frame portion.

The present embodiment relates to a card adapter 1 having an appearance shown in FIGS. 1 and 2. The card adapter 1 comprises a lower case 2 having a bottom plate 2f and sidewalls of a card inserting portion 1a (refer to FIGS. 4 and 6), a metallic cover member 4 attached to the lower case 2 for covering the card inserting portion 1a from the upper side, and an upper case 3 attached to the lower case 2 with a front-end and both sides of the cover member 4 interposed between the upper case 3 and the lower case 2.

An adapter terminal group 6 having a plurality of terminals 7 to 15 is exposed in the back surface of the lower case 2. The adapter terminal group 6 is brought into contact with a terminal group included in a card connector in a state where the card adapter 1 is inserted into the card connector (not shown). In addition, the reference numerals 5 in FIGS. 1 and 2 represent a sliding member for protecting a light.

As shown in FIG. 3, the adapter terminal group 6 is inserted into a wafer 16. The adapter terminal group 6 and the wafer 16 are fitted to a front portion of the lower case 2. In addition, the terminals 7 to 15 of the adapter terminal group 6 are exposed in the interior of the card inserting portion 1a (not shown).

In the card inserting portion 1a, a card, for example, a small SD card 20 is inserted. The small SD card 20 comprises an external terminal group 21 having a plurality of external terminals 22 to 32 exposed in a surface thereof. The external terminal group 21 and the adapter terminal group 6 are brought in contact with each other in a state where the small SD card 20 is inserted into the card inserting portion 1a.

In addition, in the lower plate 2f of the lower case 2, stopper portions 17, 18 and 19 are provided. The stopper portions 17, 18, and 19 are brought in contact with the front-end surface of the small SD card 20 in the card inserting portion 1a, and define an insertion finishing position where the insertion of the small SD card 20 into the card inserting portion 1a is finished.

Specifically, in the present embodiment, a ground contacting portion 41 that is provided in the cover member 4 and is brought in contact with the ground terminal 12, is brought in contact with the ground terminal 12 that is included in the adapter terminal group 6 and is connected to the ground in the lengthwise direction of the card inserting portion 1a.

As shown in FIGS. 3 and 4, a contacting surface 40 that protrudes from the lower plate 2f of the lower case 2 upward and faces the back end surface 1b of the card inserting portion 1a is formed on the ground terminal 12, and the ground contacting portion 41 formed at the front-end portion of the cover member 4 is brought in contact with the contacting surface 40.

As shown in FIG. 5, the ground contacting portion 41 is formed at a bent portion 4a that is obtained by bending the front-end portion of the cover member 4 at nearly a right angle toward the lower plate 2f of the lower case 2. In other words, by using a notch 4b obtained by cutting out the front-end portion of the cover member 4 in an L shape, a plate spring portion 41b extending in a widthwise direction of the card inserting portion 1a and bent in a lengthwise direction of the card inserting portion 1a, a cantilever supporting portion 41c for supporting the plate spring portion 41b in a cantilever manner, and a contacting portion 41a located at the front-end of the plate spring portion 41b and brought in contact with a contacting surface 40 of the ground terminal 12 are formed.

Specifically, in the present embodiment, a pair of engaging pawls 50 is provided on rear ends of both sides of the cover member 4, as shown in FIG. 3. As shown in FIG. 6, the engaging pawls 50 comprises locating portions, obtained by bending side end portions of the cover member 4, for locating the rear-end portion of the cover member 4 at a predetermined position in the thickness direction of the card inserting portion 1a, that is, leg portions 50b, and pawl portions 50a expanding toward the outside of the card inserting portion 1a at the front ends of the leg portions 50b.

In addition, as shown in FIG. 3, a pair of concave portions 2b in which the pawl portions 50a of the engaging pawls 50 is disposed is provided on the rear portions of both sides of the frame portion 2a of the lower case 2, respectively. As shown in FIG. 6, a pair of flange portions 2c, protruding toward the card inserting portion 1a side, is formed in the frame portions 2a. Further, transverse grooves 2d, communicating with the concave portions 2b, into which the pawl portions 50a of the engaging pawls 50 are fitted, are formed under the pair of flange portions 2c, respectively. In addition, sizes of the concave portions 2b and sizes of the pawl portions 50a in a lengthwise direction of the card inserting portion 1a are set such that they are substantially equal to each other.

In other words, in a state where the cover member 4 is located at a predetermined position of the frame portion 2a forming the sidewalls of the card inserting portion 1a, that is, a position at which each pawl portion 50a is disposed in each concave portion 2b, when the cover member 4 is slid in a lengthwise direction of the card inserting portion 1a, that is, a direction of an arrow A (see FIG. 7), each pawl portion 50a is fitted into each transverse groove 2d. In other words, locking means is constituted for locking the cover member 4 in the fame portion 2a by the pawl portions 50a and the transverse grooves 2d.

In addition, as shown in FIG. 3, a pair of engaging tongues 51 is formed in the middle of both sides of the cover member 4. The engaging tongues 51 are formed by bending the side end portions of the cover member 4. The engaging tongues 51 comprise locating portions for locating the center portion of the cover member 4 at a predetermined position in the thickness direction of the card inserting portion 1a, that is, leg portions (not shown), and tongue portions 51a expanding toward the outside of the card inserting portion 1a at the front ends of the leg portions.

In addition, the tongue portions 51a of the engaging tongues 51 are formed in the middle of both sides of the frame portion 2a, respectively. A pair of concave portions 2e is formed for allowing the tongue portions 51a to be slid by a predetermined distance in a lengthwise direction of the card inserting portion 1a.

In addition, a pair of engaging tongues 52 is formed at both sides of the front-end portion of the cover member 4. The engaging tongues 52 are formed by bending the front-end portion of the cover member 4. The engaging tongues 52 comprise locating portions for locating the front-end portion of the cover member 4 at a predetermined position in the thickness direction of the card inserting portion 1a, that is, leg portions 52b, and tongue portions 52a expanding toward the outside of the card inserting portion 1a at the front ends of the leg portions 52b.

In addition, the tongue portions 52a of the engaging tongues 52 are arranged at a rear-end portion of the wafer 16. A pair of concave portions 16a is formed for allowing the tongue portions 52a to be slid by a predetermined distance in a lengthwise direction of the card inserting portion 1a at the rear-end portion of the wafer 16.

In the present embodiment having the above-mentioned configuration, when the cover member 4 is attached to the lower case 2, firstly, the pawl portions 50a of the engaging pawls 50 are arranged in the concave portions 2b and then the tongue portions 51a of the engaging tongues 51 and the tongue portions 52a of the engaging tongues 52 are arranged in the concave portions 2e and 16a, respectively, as shown in FIG. 7.

At this time, since the sizes of the concave portions 2b and the sizes of the pawl portions 50a in a lengthwise direction of the card inserting portion 1a are substantially equal to each other, when the pawl portions 50a are arranged in the concave portions 2b, the tongue portions 51 and 52 are simultaneously arranged in the concave portions 20e and 16a, respectively.

As such, when the pawl portions 50a of the engaging pawls 50, the tongue portions 51a of the engaging tongues 51, and the tongue portions 52a of the engaging tongues 52 are arranged respectively in the concave portions, the rear-end portion, center portion, and front-end portion of the cover member 4 are located respectively at predetermined positions in a thickness direction of the card inserting portion 1a by leg portions 50b of the engaging pawls 50, leg portions of the engaging pawls 51, and leg portions 52b of the engaging pawls 52.

Next, as described above, in a state where the cover member 4 is arranged in the frame portion 2a, the cover member 4 is slid in a lengthwise direction of the card inserting portion 1a, that is, a direction of an arrow A. If so, as shown in FIG. 8, the tongue portions 51a of the engaging tongues 51 and the tongue portions 52a of the engaging tongues 52 are slid in a direction of an arrow A in the concave portions 2e and 16a of the frame portion 2a, respectively. At this time, specifically, the pawl portions 50a of the engaging pawls 50 are slid under the flange portions 2c, that is, are fitted into the transverse grooves 2d. As a result, the cover member 4 is locked into the frame portion 2a. In other words, the cover member 4 is temporarily fixed to the lower case 2.

Next, the upper case 3 is attached to the lower case 2 from the upper side of the cover member 4 that is temporarily fixed to the lower case 2, as describe above. At this time, the tongue portions 51a of the engaging tongues 51 are sandwiched between the frame portion 2a of the lower case 2 and the side portions of the upper case 3 in the concave portions 2e. The tongue portions 52a of the engaging tongues 52 are sandwiched between the wafer 16 and the front portion of the upper case 3 in the concave portions 16a. As a result, the floating of the cover member 4 from the lower case 2 can be suppressed.

Furthermore, as shown in FIG. 7, in the state where the cover member 4 is arranged at the frame portion 2a, the ground contacting portion 41 of the cover member 4 is in the vicinity of the contacting surface 40 of the ground terminal 12. In addition, when the cover member 4 is slid in a direction of an arrow A, the contacting portion 41a of the ground contacting portion 41 is pressed against the contacting surface 40 of the ground terminal 12 and thus the plate spring portion 41b is bent, as shown in FIG. 8. In other words, in the ground contacting portion 41, the contacting portion 41a is brought into contact with the contacting surface 40 of the ground terminal 12 through the elastic force of the plate spring portion 41b.

According to the present embodiment, the following effects are obtained.

According to the present embodiment, the contacting portion 41a of the ground contacting portion 41 is brought into contact with the contacting surface 40 of the ground terminal 12 in the lengthwise direction of the card inserting portion 1a. For this reason, even when the cover member 4 floats, the ground contacting portion 41 is not be separated from the ground terminal 12. As a result, when a card is inserted into the card inserting portion 1a, it is possible to prevent the contact failure between the cover member 4 and the ground terminal 12 from occurring. Consequently, the card and the card adapter can be protected from static electricity or the like.

Further, according to the present embodiment, since the ground contacting portion 41 comprises a plate spring portion 41b that is bent in the lengthwise direction of the card inserting portion 1a and is supported by the cantilever supporting portion in a cantilever manner, it is possible to press the contacting portion 41a against the contacting surface 40 of the ground terminal 12 to be brought into contact with each other through elastic force of the plate spring portion 41b. As a result, it is possible to stabilize the contact of the ground contacting portion 41 to the ground terminal 12. Consequently, the card and the card adapter can be protected from static electricity or the like.

Furthermore, according to the present embodiment, the plate spring portion 41b of the ground contacting portion 41 is formed so as to extend in the widthwise direction of the card inserting portion 1a. As a result, it is possible to provide elasticity to the ground contacting portion 12 without enlarging the ground contacting portion 12 in the thickness direction of the card inserting portion 1a. Therefore, the card adapter 1 need not be increased in size.

Furthermore, according to the present embodiment, by having the locking means, that is, the pawl portions 50a of the engaging pawls 50 and the transverse grooves 2d of the frame portion 2a, when the cover member 4 is slid in a direction in which the cover member 4 is inserted, the cover member 4 is locked into the frame portion 2a. As a result, the cover member 4 can be temporarily fixed to the lower case 2 more easily. Therefore, it is possible to easily assemble the cover member 4.

Furthermore, according to the present embodiment, by having the locating portions, that is, the leg portions 50b of the engaging pawls 50, the leg portions of the engaging tongues 51, and the leg portions 52b of the engaging tongues 52, the cover member 4 can be accurately arranged at a predetermined position in the thickness direction of the card inserting portion 1a. As a result, the contacting portion 41a of the ground contacting portion 41 can be accurately arranged on the contacting surface 40 of the ground terminal 12. Therefore, it is possible to stabilize the contact of the ground contacting portion 41 to the ground terminal 12 and to consequently protect the card and the card adapter from static electricity or the like.

1. A card adapter, comprising:
a card inserting portion into which a card having an external terminal group exposed in a surface thereof is inserted;
an adapter terminal group that is exposed in the interior and exterior of the card inserting portion and is brought into contact with the external terminal group of the card inserted into the card inserting portion; and
a metallic cover member covering the card inserting portion and having a ground contacting portion which is brought into contact with a ground terminal of the adapter terminal group,
wherein the ground contacting portion is brought into contact with the ground terminal in a lengthwise direction of the card inserting portion.

2. The card adapter according to claim 1,
wherein the ground terminal has a contacting surface facing a back-end surface of the card inserting portion,
wherein the ground contacting portion is formed in a bent portion obtained by bending a front-end portion of the cover member, and
wherein the ground contacting portion comprises a plate spring portion extending in a widthwise direction of the card inserting portion and bent in a lengthwise direction of the card inserting portion and a cantilever supporting portion for supporting the plate spring portion in a cantilever manner.

3. The card adapter according to claim 1, further comprising:
locking means,
wherein the locking means locks the cover member in a frame portion by sliding the cover member in a lengthwise direction of the card inserting portion in a state where the cover member is arranged at a predetermined position of the frame portion which forms sidewalls of the card inserting portion.

4. The card adapter according to claim 2, further comprising:
locking means,
wherein the locking means locks the cover member in a frame portion by sliding the cover member in a lengthwise direction of the card inserting portion in a state where the cover member is arranged at a predetermined position of the frame portion which forms sidewalls of the card inserting portion.

5. The card adapter according to claim 1,
wherein locating portions for locating the cover member in a thickness direction of the card inserting portion are formed in the cover member.

6. The card adapter according to claim 2,
wherein locating portions for locating the cover member in a thickness direction of the card inserting portion are formed in the cover member.

7. The card adapter according to claim 3,
wherein locating portions for locating the cover member in a thickness direction of the card inserting portion are formed in the cover member.

8. The card adapter according to claim 4,
wherein locating portions for locating the cover member in a thickness direction of the card inserting portion are formed in the cover member.

9. The card adapter according to claim 3,
wherein the locking means comprises transverse grooves communicating with a pair of concave portions provided in a lower case and pawl portions of a pair of engaging pawls of the cover member.

10. The card adapter according to claim 4,
wherein the locking means comprises transverse grooves communicating with a pair of concave portions provided in a lower case and pawl portions of a pair of engaging pawls of the cover member.

11. The card adapter according to claim 5,
wherein the locating portions are a plurality of leg portions provided in the cover member.

12. The card adapter according to claim 6,
wherein the locating portions are a plurality of leg portions provided in the cover member.

13. The card adapter according to claim 7,
wherein the locating portions are a plurality of leg portions provided in the cover member.

14. The card adapter according to claim 8,
wherein the locating portions are a plurality of leg portions provided in the cover member.
